(19) United States
(12) Patent Application Publication
(10) Pub. No.: US 2008/0098117 A1
(43) Pub. Date: Apr. 24, 2008

(54) METHOD, APPARATUS, AND COMPUTER PRODUCT FOR SETTING TRANSMISSION PATH

(75) Inventors: Ryuji Fukuhara, Fukuoka (JP); Ryuji Oda, Fukuoka (JP); Yosuke Gondo, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/850,828

(22) Filed: Sep. 6, 2007

(30) Foreign Application Priority Data
Oct. 20, 2006 (JP) 2006-286856

(51) Int. Cl. G06F 15/177

(52) U.S. Cl. 709/227

(57) ABSTRACT

A communication state between a session initiation protocol server and another session initiation protocol server to be a destination for transmitting a request message is determined. When it is determined that the communication state is in a communication unavailable state, a subsequent session initiation protocol server of the session initiation protocol server designated as the destination is determined to be a new destination based on information on a relay order of the session initiation protocol servers set in header information of the request message.

### BACKGROUND OF THE INVENTION

1. Field of the Invention

The present invention relates to a technology for setting a transmission path for transmitting a session initiation protocol message.

2. Description of the Related Art

Information communication infrastructure has been increasingly developed so that various services, such as an Internet protocol (IP) phone, a video conference, and an instant message, for realizing a one-to-one, a one-to-many, and a many-to-many communications in which a plurality of participants can be involved through an IP network, are becoming available.

In a system that realizes such communication services, communication is performed between the participants in units of session including a series of communications (hereinafter, “a session communication”). A session initiation protocol (SIP) is widely known as a protocol for performing initiation, change, and termination of the session communication in IP networks.

In the network using the SIP, communication between a terminal device of a transmitter-side (hereinafter, “user agent client (UAC)”) and a terminal device of a receiver-side (hereinafter, “user agent server (UAS)”) is performed via a plurality of SIP servers. Specifically, a SIP message including various types of request messages and various types of response messages is transmitted and received between the UAC and the UAS via the SIP servers.

FIG. 9 is a schematic diagram of an IP phone network using the SIP. In the IP phone network shown in FIG. 9, a communication is performed between a UAC and a UAS via a SIP server A, a SIP server N, and a SIP server X, in that order.

If one of the SIP servers A, N, and X is down, a request message transmitted from the UAC will not reach the UAS and a request message from the UAS will not reach the UAC, either.

A conventional technology for establishing an alternative path, from which a failed SIP server is excluded for transmitting an INVITE request (a request message transmitted from the UAC for triggering a start of the session communication), is disclosed in Japanese Patent Application Laid-Open No. 2004-179764. In the conventional technology, a source SIP server transmits an INVITE request to a destination SIP server, and if a response message to the INVITE request is not returned from the destination SIP server, the source SIP server determines that a failure has occurred in the destination SIP server. If a failure has occurred in the destination SIP server, the source SIP server establishes an alternative path, which detours the down destination SIP server, and transmits the INVITE request through the alternative path.

Thus, in the above technology, whether a failure has occurred is determined based on whether a response is received to the INVITE message. In this scheme, however, if failure occurs in the SIP server after the session communication is started, it is difficult to detect the failure in the SIP server. Because a SIP server is unable to detect such a failure, the SIP server wrongly assumes that session communication is continuing, although actually the session communication has been interrupted due to a failure. In such a situation, the SIP server continuously performs a billing process to the UAC despite the fact that the session communication is off.

For example, in the IP phone network shown in FIG. 9, assume that the SIP server A performs billing process to the UAC and the SIP server N goes down while the session communication between the UAC and the UAS is continued. In this case, if the UAS transmits a BYE request for terminating the session communication, the SIP server A can not receive the BYE request, so that the SIP server A continues the billing process to the UAC.

In the extended specification of the SIP (RFC4028) determined by the Internet engineering task force (IETF), a session timer function for checking a state of the session communication is defined. With the session timer function, each of the UAC, the UAS, and the SIP server determines a session live time for the communication between the device and other devices at a start of the session communication (session timer). In addition, an elapsed time is continuously measured by a timer, so that a re-INVITE request is transmitted to a device designated as a destination of the communication (the UAC or the UAS) in a half of the session live time (refresh timer).

Upon receiving the response to a transmitted request, each of the UAC, the UAS, and the SIP server determines that the communication is available, thus resetting the timer and repeating to check whether the re-INVITE request is transmitted and a response to the re-INVITE request is received. On the other hand, if the response is not returned after the session live time elapsed, each of the UAC, the UAS, and the SIP server determines that the communication is unavailable.

In this case, even if the session timer function is included in the SIP server A, it is difficult to detect the occurrence of the failure during a time from a start of a transmission of the re-INVITE request to an end of the session live time with no response returned, resulting in a continuation of the billing process. Thus, it is difficult to resolve the above problem even with the session timer function.

Therefore, the SIP server needs a configuration that the session communication is continued even when a failure occurs in the SIP server during the session communication, by, for example, establishing an alternative path from which a failed SIP server is excluded, for relaying the SIP message.

Thus, there is a demand for maintaining the session communication between the UAC and the UAS even when the failure occurs in the SIP server during the session communication.

### SUMMARY OF THE INVENTION

It is an object of the present invention to at least partially solve the problems in the conventional technology.

According to an aspect of the present invention, there is provided an apparatus that sets a transmission path of a session initiation protocol message from a first communication device to a fourth communication device via a plurality of other communication devices that relay the session initiation protocol message based on information included in the session initiation protocol message, the communication devices being connected to each other via a network, the other communication devices including a second communication device that is downstream of the first communication device in the communication path, and a third communication device that is downstream of the second communication device in the communication path. The apparatus includes a communication-state determining unit that determines a communication state between the first communication device and the second communication device; and a transmission-path setting unit that changes the information included in the session initiation protocol message, when the communication-state determining unit determines that communication is unavailable between the first communication device and the second communication device, to change a destination of the session initiation protocol message from the second communication device to the third communication device.

According to another aspect of the present invention, there is provided a method of setting a transmission path of a session initiation protocol message from a first communication device to a fourth communication device via a plurality of other communication devices that relay the session initiation protocol message based on information included in the session initiation protocol message, the communication devices being connected to each other via a network, the other communication devices including a second communication device that is downstream of the first communication device in the communication path, and a third communication device that is downstream of the second communication device in the communication path. The method includes determining a communication state between the first communication device and the second communication device; and changing the information included in the session initiation protocol message, when it is determined at the determining that communication is unavailable between the first communication device and the second communication device, to change a destination of the session initiation protocol message from the second communication device to the third communication device.

According to still another aspect of the present invention, there is provided a computer-readable recording medium that causes a computer to realize the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a concept of a session initiation protocol (SIP) server according to an embodiment of the present invention;

FIG. 2 is a diagram for explaining a transmission-path setting process for transmitting a message performed by the SIP server shown in FIG. 1;

FIG. 3 is a functional block diagram of the SIP server shown in FIG. 1;

FIG. 4 is a sequence diagram of a process performed by the SIP server shown in FIG. 1 when the SIP server has detected an occurrence of a failure;

FIG. 5 is a sequence diagram of a process performed by the SIP server shown in FIG. 1 when the SIP server has detected a failure recovery;

FIG. 6 is a sequence diagram of a process performed by the SIP server shown in FIG. 1 when the SIP server has not detected a failure recovery;

FIG. 7 is a sequence diagram of a process performed by the SIP server shown in FIG. 1 when the SIP server has not detected a failure recovery;

FIG. 8 is a functional block diagram of a computer terminal that executes a transmission-path setting program according to the embodiment; and

FIG. 9 is a schematic diagram of an Internet protocol (IP) phone network with the SIP employed.

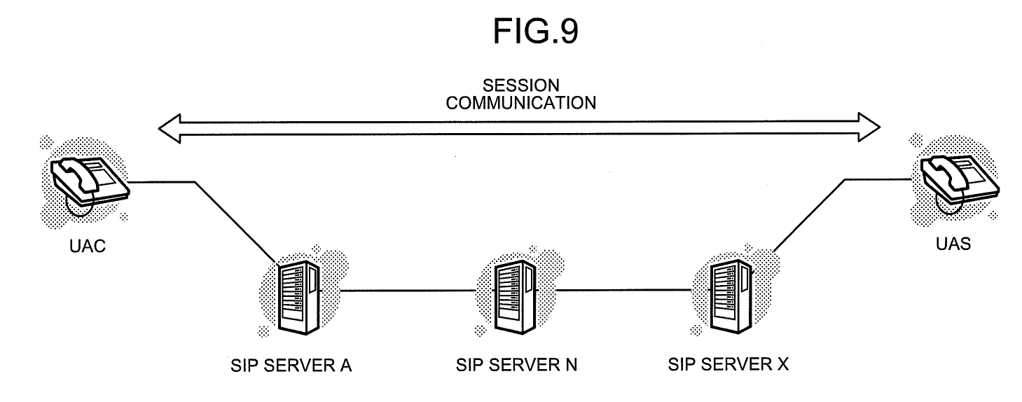

### DETAILED DESCRIPTION OF THE PREFERRED EMBODIMENTS

Exemplary embodiments of the present invention are explained in detail below with reference to the accompanying drawings. According to the embodiments, it is assumed that the present invention is applied to a session initiation protocol (SIP) server constituting a network for an Internet protocol (IP) phone. However, the present invention is not to be limited an SIP server.

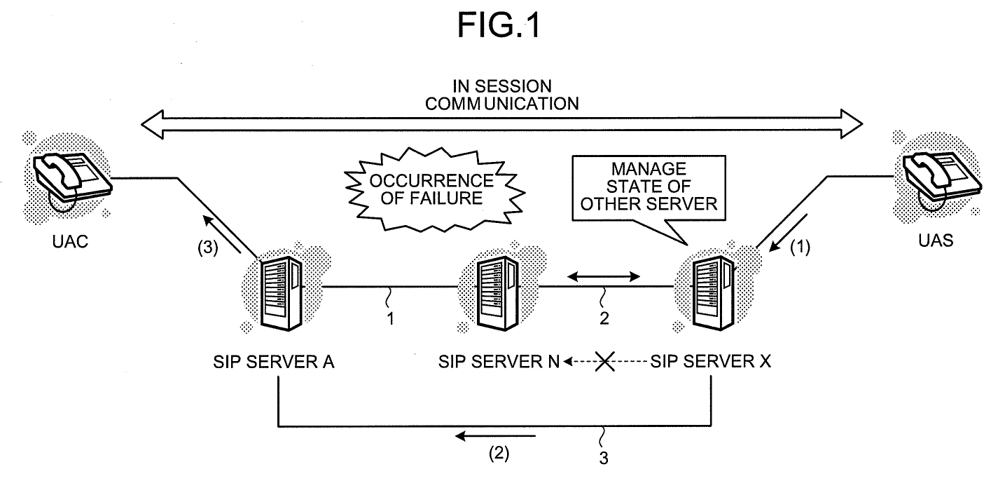

FIG. 1 is a schematic diagram for explaining a concept of a SIP server according to an embodiment of the present invention. An IP phone network shown in FIG. 1 includes SIP servers A, N, and X according to the embodiment. The SIP servers A and N are connected to each other via an IP network 1, the SIP servers N and X via an IP network 2, and the SIP servers A and X via an IP network 3.

A user agent client (UAC) is a terminal device used by a transmitter, while a user agent server (UAS) is a terminal device used by a receiver. In the example shown in FIG. 1, the UAC and the UAS are IP phones that perform a communication related to a call via the SIP servers A, N, and X.

Each of the SIP servers A, N, and X continuously monitors a communication state, i.e., whether communication is possible, between a first SIP server and a second SIP server that are connected to each other, and manages a result obtained by a check as a communication state information. For example, the SIP server A monitors and manages a communication state between itself and the SIP server N, the SIP server N monitors and manages a communication state between itself and the SIP server A and between itself and the SIP server X, and the SIP server X manages a communication state between itself and the SIP server N.

Assume now that a session communication is started between the UAC and the UAS after transmitting and receiving a message including an INVITE message with each other using a SIP protocol. Thereafter, a BYE request for terminating the session communication is transmitted from the UAS (see (1) of FIG. 1). In this case, a transmission path for the BYE request is set in header information of the BYE request, and the transmission path is established so that a message is transmitted via the SIP servers X, N, and A, in that order.

Upon receiving the BYE request and by referring to the header information of the BYE request, the SIP server X determines that the next destination of the BYE request is the SIP server N, and checks whether the SIP server N is in a communication available state based on the communication information managed.

If the SIP server N is not in the communication available state due to an occurrence of a failure, the SIP server X transmits the BYE request to the SIP server A, which is the subsequent destination of the BYE request, without transmitting the BYE request to the SIP server N (see (2) of FIG. 1). In this case, the SIP server X deletes information on the SIP server N from the transmission path set in the header information of the BYE request to transmit the BYE request to the SIP server A.

Upon receiving the BYE request, the SIP server A transmits the BYE request to the UAC, which is the last destination of the BYE request (see (3) of FIG. 1). Thus, the session communication is terminated when the BYE request reaches the UAC.

In this manner, the SIP server determines a communication state between an originating SIP server and a destination SIP server of a request message. If it is determined that the communication state of the destination SIP server is in a communication unavailable state, another SIP server designated as the subsequent destination of the destination SIP server is determined to be a new destination of the request message, based on information on a relay order set in the header information of the request message, by which the request message is relayed among the SIP servers.

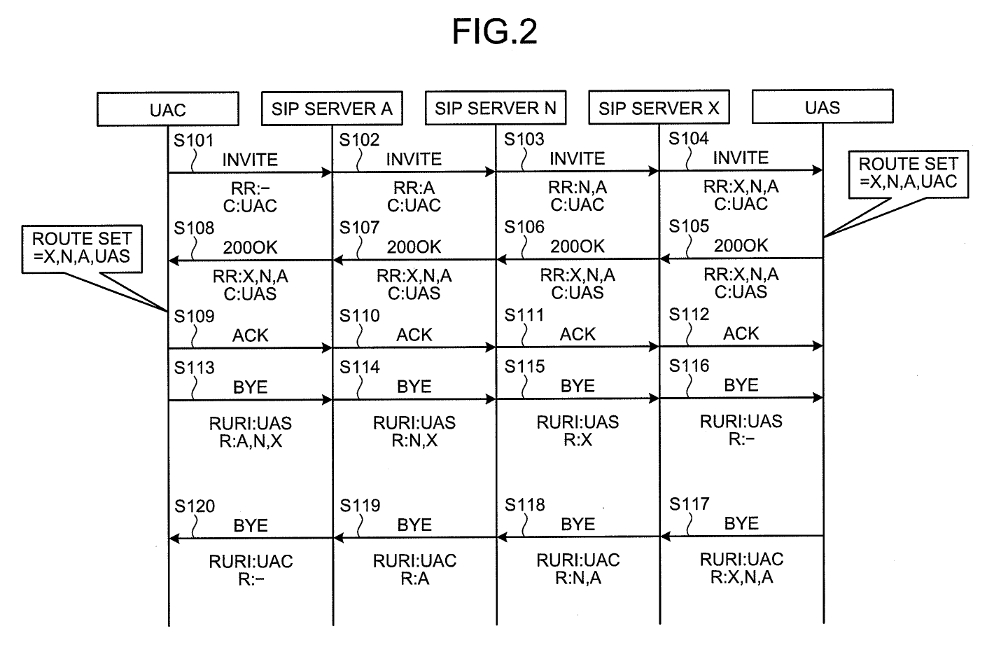

FIG. 2 is a diagram for explaining a transmission-path setting process for transmitting a message performed by the SIP servers A, N, and X shown in FIG. 1.

Upon receiving a SIP message from the UAC, the UAS, or the other SIP servers, each of the SIP servers A, N, and X specifies a destination for each transmission to transfer the SIP message. The destination is specified based on a route set generated by the UAC and the UAS at a start of the session communication. The route set is generated based on a record-route header and a contact header included in the header information of the INVITE request and a response message to the INVITE request.

The record-route header is a header in which a transmission path of the INVITE request is set. Specifically, information indicating the SIP servers through which the INVITE request has been transmitted on the transmission path of the INVITE request is set in order of transmission. On the other hand, the contact header is a header in which information on a source device that has transmitted the INVITE request and the response message is set.

For example, as shown in FIG. 2, the INVITE request for the UAS is transmitted from the UAC (step S101), the INVITE request is transferred to the SIP servers A, N, and X in that order, and reaches the UAS (steps S102 to S104). In this case, information indicating the SIP servers A, N, and X, through which the INVITE request has been transferred, is set in the record-route header of the INVITE request, in order of transmission or in a reverse order of transmission (see “RR: X, N, A” in FIG. 2). On the other hand, information indicating the UAC as the source device of the INVITE request is set in the contact header (“C: UAC” shown in FIG. 2).

Upon receiving the INVITE request, the UAS generates the route set based on the record-route header and the contact header of the INVITE request (“X, N, A, UAC” shown in FIG. 2). The UAS transmits a 200-OK response (response message in which a response code “200 OK” is set) indicating a reception of the INVITE request for starting a session to the UAC (step S105).

The 200-OK response transmitted from the UAS is transferred to the SIP servers X, N, and A in that order, which is opposite to the order for transferring the INVITE request, and reaches the UAC (steps S106 to S108). The same information as that in the record-route header of the INVITE request received by the UAS is set in the record-route header of the 200-OK response (“RR: X, N, A” shown in FIG. 2). On the other hand, information indicating the UAS as the source device of the 200-OK response is set in the contact header (“C: UAS” shown in FIG. 2).

Upon receiving the 200-OK response, the UAC generates the route set based on the record-route header and the contact header of the 200-OK response (“X, N, A, UAS” shown in FIG. 2). The UAC transmits an ACK message indicating a reception of the 200-OK response to the INVITE request to the UAS (step S109). The ACK message transmitted by the UAC is transferred to the SIP servers A, N, and X in that order, which is the same as that for transferring the INVITE message, and reaches the UAS (steps S110 to S112).

With the above processes, a session communication is started between the UAC and the UAS (session communication is on line). Thereafter, the transmission path is set in the header of the request message transmitted from the UAC or the UAS, based on the route set generated in each of the terminals, and each of the SIP servers specifies the next destination of the request message based on the transmission path.

For example, as shown in FIG. 2, when the BYE request for terminating the session is transmitted from the UAC to the UAS (step S113), a request-URI header and a route header of the BYE request is set in the UAC based on the route set (“RURI: UAS” and “R: A, N, X” shown in FIG. 2).

The request-URI header is a header in which information indicating the source device of the request message (destination of the request) is set. The route header is a header in which information indicating the transmission path for transmitting the request message (order of the SIP servers for transmitting the request message) is set.

The BYE request transmitted from the UAC is transferred to the SIP servers A, N, and X in that order, and reaches the UAS (steps S114 to S116).

When the BYE request is transmitted from the UAS to the UAC (step S117), the request-URI header and the route header of the BYE request is set in the UAS based on the route set (“RURI: UAC” and “R: X, N, A”). The BYE request is transferred to the SIP servers X, N, and A in that order, and reaches the UAC (steps S118 to S120).

In this manner, in the network using the SIP protocol, after the session communication is started between the UAC and the UAS, the transmission path is set in the route header of the request message transmitted from the UAC and the UAS, based on the route set generated in each of the terminals. Subsequently, each of the SIP servers specifies the destination of the request message based on the transmission path.

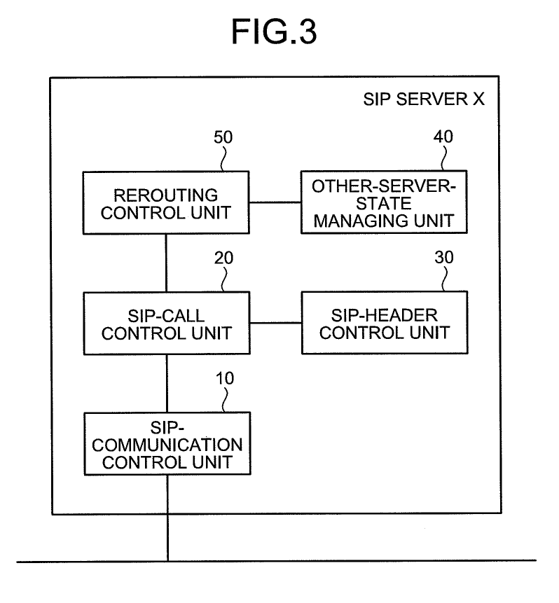

A configuration of the SIP server X is described below. The configurations of the SIP servers A and N are the same as those of the SIP server X, and therefore, explanations thereof are omitted. FIG. 3 is a functional block diagram of the SIP server X. The SIP server X includes a SIP-communication control unit 10, a SIP-call control unit 20, a SIP-header control unit 30, an other-server-state managing unit 40, and a rerouting control unit 50.

The SIP-communication control unit 10 controls a transmission/reception of a SIP message compliant to the SIP protocol. For example, the SIP-communication control unit 10 performs a transmission/reception with the other servers, of the request message including the INVITE request, the BYE request, and a re-INVITE request, as well as the response message in which the response code such as “200 OK” and “100 Trying” is set.

The SIP-call control unit 20 performs a call control using the SIP protocol. The SIP-call control unit 20 sends a query whether to skip a destination SIP server designated as the destination to the rerouting control unit 50 at a transmission of the request message. When instructed by the rerouting control unit 50 to skip the destination SIP server, the SIP-call control unit 20 determines that the destination SIP server is in a communication unavailable state and instructs the SIP-header control unit 30 to delete the information on the destination SIP server from the transmission path set in the header information of the request message. Thereafter, the SIP-call control unit 20 directly transmits the request message to the other SIP server set as a subsequent destination of the destination SIP server to be skipped.

On the other hand, when instructed by the rerouting control unit 50 not to skip the destination SIP server, the SIP-call control unit 20 transmits the request message to the destination SIP server based on the transmission path set in the header information of the request message. In this case, when the destination SIP server is in normal operation, the response message indicating that the request message is normally received is returned. On the contrary, when a failure occurs in the destination SIP server, the response message indicating that the request message is not normally received is returned, or the response message itself is not returned.

When the response message in which the response code indicating a service unavailable state (e.g., “503 service unavailable”) is returned from the destination SIP server, or when the response message is not returned from the destination SIP server after a predetermined time elapsed, the SIP-call control unit 20 determines that the destination SIP server is in the communication unavailable state. Subsequently, the SIP-call control unit 20 instructs the SIP-header control unit 30 to delete the information on the destination SIP server from the transmission path set in the header information of the request message, resulting in directly transmitting the request message to the other SIP server set as a subsequent destination of the SIP server.

As described above, it is assumed that, when it is determined that the destination SIP server is in the communication unavailable state, the SIP-call control unit 20 directly transmits the request message to the other SIP server designated as a destination of the destination SIP server in the communication unavailable state. However, it is possible to check the communication state of the other SIP server so that the request message is transmitted to still another SIP server when it is determined that the other SIP server is in the communication unavailable state.

Furthermore, it is possible for the SIP-call control unit 20 to select one SIP server as the next destination from among the SIP servers other than the SIP server in the communication unavailable state, when it is determined that the destination SIP server is in the communication unavailable state, so that the request message is transmitted to a selected SIP server.

The SIP-header control unit 30 edits the header of the SIP message. The SIP-header control unit 30 deletes the information on the destination SIP server from the transmission path set in the route header of the request message, based on the instruction issued by the SIP-call control unit 20.

In this manner, when it is determined that the destination SIP server is in the communication unavailable state, the SIP-call control unit 20 instructs the SIP-header control unit 30 to delete the information on the destination SIP server from the transmission path set in the route header of the request message. Accordingly, it is possible to set an alternative path from which the SIP server with the failure occurred is excluded, for transmitting the request message.

The other-server-state managing unit 40 manages communication state between the server and the other server. The other-server-state managing unit 40 continuously checks whether the communication is available between the server and the other server, and stores communication state information generated based on a result obtained by a check in a memory (not shown). When receiving a query for checking the communication state of the other server from the rerouting control unit 50, the other-server-state managing unit 40 checks the communication state of the specified other server by referring to the communication state information and notifies a check result to the rerouting control unit 50.

The rerouting control unit 50 determines whether to skip the destination SIP server at a time of transmission of the request message. Specifically, the rerouting control unit 50 sends a query to the other-server-state managing unit 40 in response to the query from the SIP-call control unit 20 to check whether the destination SIP server designated as the destination of the request message is in the communication available state. When the destination SIP server is not in the communication available state, the rerouting control unit 50 instructs the SIP-call control unit 20 to skip the destination SIP server. On the other hand, when the destination SIP server is in the communication available state, the rerouting control unit 50 instructs the SIP-call control unit 20 not to skip the destination SIP server.

A process performed by the SIP server according to the embodiment is described below. In the examples, cases are considered assuming that a failure occurs in the SIP server N after the session communication is started between the UAC and the UAS through the procedures described in connection with FIG. 2.

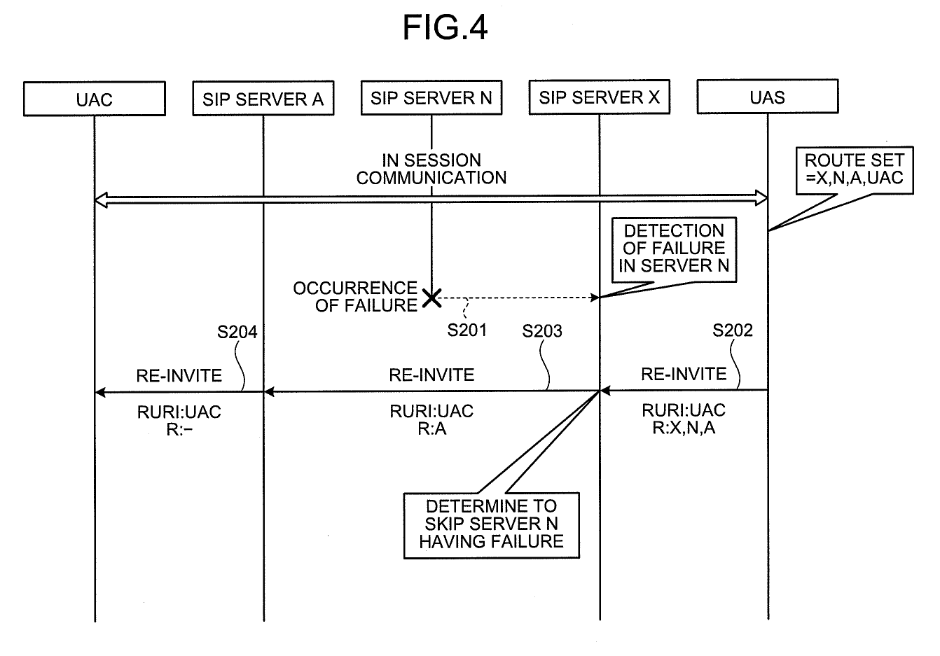

A case in which the SIP server X detects the failure after the failure occurs in the SIP server N is described below. FIG. 4 is a sequence diagram of a process performed by the SIP servers A, N, and X when the SIP server X has detected the occurrence of a failure in the SIP server N. It is assumed that the failure occurs in the SIP server N during the session communication between the UAC and the UAS, and the SIP server X detects the occurrence of the failure (step S201).

In this case, for transmitting the re-INVITE request, the UAS sets the “RURI: UAC” to the request-URI header and “R: X, N, A” (transmission path for transferring a message to the SIP servers X, N, and A in that order) to the route header. Thereafter, the UAS transmits the re-INVITE request to the SIP server X based on the transmission path set in the route header (step S202).

In the SIP server X, the SIP-communication control unit 10 receives the re-INVITE request, and the SIP-call control unit 20 acquires the next destination of the re-INVITE request based on the route header. In this case, the SIP-communication control unit 10 acquires information indicating that the SIP server N is designated as the destination. The SIP-call control unit 20 sends a query whether to skip the destination (the SIP server N) acquired by the SIP-communication control unit 10 to the rerouting control unit 50.

The rerouting control unit 50 sends a query whether the SIP server N is in the communication available state to the other-server-state managing unit 40. In this case, the occurrence of the failure in the SIP server N is detected, so that the other-server-state managing unit 40 sends a notice indicating that the SIP server N is in the communication unavailable state. In response to the notice, the rerouting control unit 50 instructs the SIP-call control unit 20 to skip the SIP server N.

Upon receiving the instruction from the rerouting control unit 50, the SIP-call control unit 20 instructs the SIP-header control unit 30 to delete the information on the SIP server N from the transmission path set in the route header of the re-INVITE request. Accordingly, the destination of the re-INVITE request is changed to the SIP server A. The SIP-call control unit 20 transmits the re-INVITE request with the route header edited to the SIP server A via the SIP-communication control unit 10 (step S203).

The re-INVITE request transmitted from the SIP server X is transferred to the SIP server A based on the transmission path set in the route header and transferred from the SIP server A to the UAC (step S204).

In this manner, when the SIP server X detects the occurrence of a failure after the failure occurs in the SIP server N, the rerouting control unit 50 sends a query to the other-server-state managing unit 40 in the SIP server X so that it is determined that the SIP server N is in the communication unavailable state. Subsequently, the SIP-call control unit 20 skips the SIP server N to transmit the re-INVITE request to the SIP server A. As a result, it is possible to continue the session communication between the UAC and the UAS.

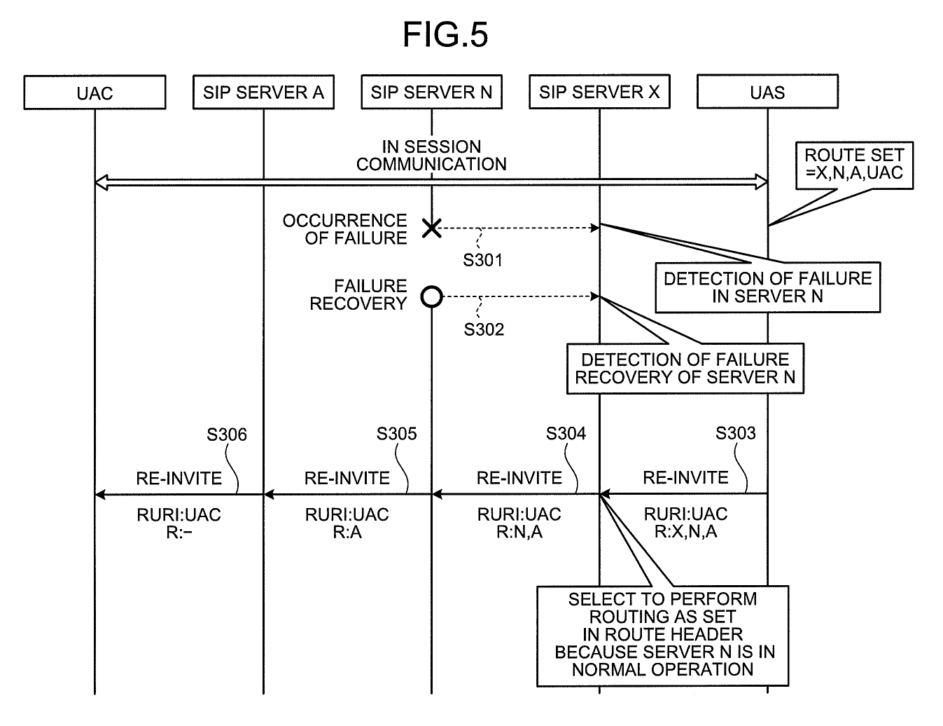

A case in which the failure occurred in the SIP server N is recovered and the SIP server X detects a failure recovery is described below. FIG. 5 is a sequence diagram of a process performed by the SIP servers A, N, and X when the SIP server X detects the failure recovery. It is assumed that the failure occurs in the SIP server N during the session communication between the UAC and the UAS (step S301), and the failure is recovered and the SIP server X detects the failure recovery (step S302).

In this case, for transmitting the re-INVITE request, the UAS sets the “RURI: UAC” to the request-URI header and “R: X, N, A” (transmission path for transferring a message to the SIP servers X, N, and A in that order) to the route header. Subsequently, the UAS transmits the re-INVITE request to the SIP server X based on the transmission path set in the route header (step S303).

In the SIP server X, the SIP-communication control unit 10 receives the re-INVITE request, and the SIP-call control unit 20 acquires information on the destination of the re-INVITE request based on the route header. In this case, the SIP-communication control unit 10 acquires information indicating that the SIP server N is designated as the destination. The SIP-call control unit 20 sends a query whether to skip the destination (the SIP server N) acquired by the SIP-communication control unit 10 to the rerouting control unit 50.

The rerouting control unit 50 sends a query whether the SIP server N is in the communication available state to the other-server-state managing unit 40. In this case, the failure recovery in the SIP server N is detected, so that the other-server-state managing unit 40 sends a notice indicating that the SIP server N is in the communication available state. In response to the notice, the rerouting control unit 50 instructs the SIP-call control unit 20 not to skip the SIP server N.

Upon receiving the instruction from the rerouting control unit 50, the SIP-call control unit 20 transmits the re-INVITE request without changing the transmission path set in the route header. Accordingly, it is determined that the next destination of the re-INVITE request is the SIP server N, which is the same as that set for receiving the re-INVITE request. The SIP-call control unit 20 transmits the re-INVITE request with the route header edited to the SIP server N via the SIP-communication control unit 10 (step S304).

The re-INVITE request transmitted from the SIP server X is transferred to the SIP server N based on the transmission path set in the route header and transferred from the SIP server N to the SIP server A (step S305). Subsequently, the re-INVITE request is transferred from the SIP server A to the UAC (step S306).

In this manner, when the failure occurred in the SIP server N is recovered and the SIP server X detects the failure recovery, the rerouting control unit 50 sends a query to the other-server-state managing unit 40 in the SIP server X, so that it is determined that the SIP server N is in the communication available state. Thereafter, the SIP-call control unit 20 transmits the re-INVITE request to the SIP server N without skipping the SIP server N. As a result, it is possible to continue the session communication between the UAC and the UAS.

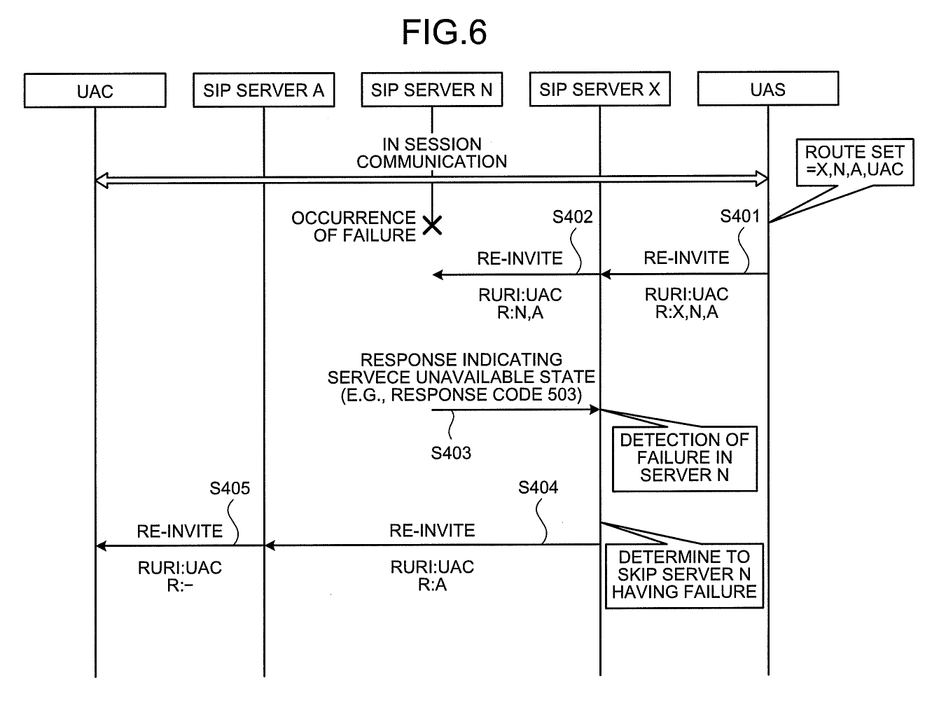

A case in which the SIP server X does not detect the occurrence of the failure after the failure occurs in the SIP server N is described below. FIG. 6 is a sequence diagram of a process performed by the SIP servers A, N, and X when each of the SIP servers does not detect the occurrence of the failure. It is assumed that the failure occurs in the SIP server N during the session communication between the UAC and the UAS and the SIP server X does not detect the occurrence of the failure.

In this case, for transmitting the re-INVITE request, the UAS sets the “RURI: UAC” to the request-URI header and “R: X, N, A” (transmission path for transferring a message to the SIP servers X, N, and A in that order) to the route header. Thereafter, the UAS transmits the re-INVITE request to the SIP server X based on the transmission path set in the route header (step S401).

In the SIP server X, the SIP-communication control unit 10 receives the re-INVITE request, and the SIP-call control unit 20 acquires information on the destination of the re-INVITE request based on the route header. In this case, the SIP-communication control unit 10 acquires information indicating that the SIP server N is designated as the destination. The SIP-call control unit 20 sends a query whether to skip the destination (the SIP server N) acquired by the SIP-communication control unit 10 to the rerouting control unit 50.

The rerouting control unit 50 sends a query whether the SIP server N is in the communication available state to the other-server-state managing unit 40. In this case, the occurrence of the failure in the SIP server N is not detected, so that the other-server-state managing unit 40 sends a notice indicating that the SIP server N is in the communication available state. In response to the notice, the rerouting control unit 50 instructs the SIP-call control unit 20 not to skip the SIP server N.

Upon receiving the instruction from the rerouting control unit 50, the SIP-call control unit 20 transmits the re-INVITE request without changing the transmission path set in the route header. Accordingly, it is determined that the destination of the re-INVITE request is the SIP server N, which is the same as that set for receiving the re-INVITE request. The SIP-call control unit 20 transmits the re-INVITE request with the route header edited to the SIP server N via the SIP-communication control unit 10 (step S402).

At this state, the SIP server N is in the communication unavailable state due to the occurrence of the failure, so that a response message including a response code indicating that the server is unavailable (e.g., “503 service unavailable”) is returned from the SIP server N to the SIP server X (step S403).

In this case, in the SIP server X, the SIP-communication control unit 10 receives the response message, and the SIP-call control unit 20 determines that the SIP server N is in the communication unavailable state based on the response message, so that the SIP-call control unit 20 instructs the SIP-header control unit 30 to delete the information on the SIP server N from the transmission path set in the route header of the re-INVITE request. Accordingly, the destination of the re-INVITE request is changed to the SIP server A. The SIP-call control unit 20 transmits the re-INVITE request with the route header edited to the SIP server A via the SIP-communication control unit 10 (step S404).

The re-INVITE request transmitted from the SIP server X is transferred to the SIP server A based on the transmission path set in the route header and transferred from the SIP server A to the UAC (step S405).

In this manner, when the failure occurs in the SIP server N and the SIP server X does not detect the occurrence of the failure, the SIP-call control unit 20 in the SIP server X transmits the re-INVITE request to the SIP server N, checks the response code of the response message to the re-INVITE request to determine whether the SIP server N is in the communication unavailable state. When it is determined that the SIP server N is in the communication unavailable state, the SIP server X skips the SIP server N to transmit the re-INVITE request to the SIP server A, which has been the destination of the SIP server N. As a result, it is possible to continue the session communication between the UAC and the UAS.

In the above embodiment, it is described that the response message including the response code indicating a service unavailable state is returned from the SIP server at a time of the transmission of the re-INVITE request from the SIP server X to the SIP server N. On the other hand, there is a case in which the response message itself is not returned from the SIP server N because the SIP server N is in the service unavailable state or is down.

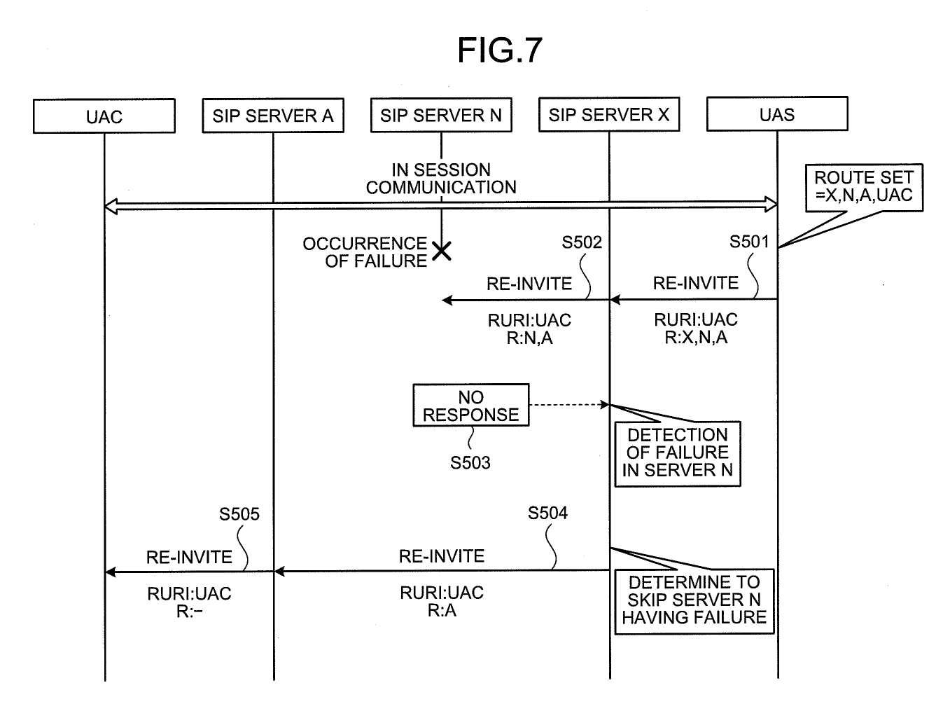

FIG. 7 is a sequence diagram of a process performed by the SIP servers A, N, and X when the SIP server X does not detect the failure recovery. The process procedures at steps S501, S502, and S505 are the same as those at steps S401, S402, and S405 described in connection with FIG. 6, and therefore, explanations thereof are omitted.

It is assumed that the SIP-call control unit 20 of the SIP server X transmits the re-INVITE request with the route header edited to the SIP server N via the SIP-communication control unit 10 through the same procedures described in connection with steps S401 and S402 shown in FIG. 6 (steps S501 and S502).

At this state, it is assumed that the response message is not returned from the SIP server N to the SIP server X even after a predetermined time elapsed, because the SIP server N is down due to the occurrence of the failure (step S503).

In this case, the SIP-call control unit 20 of the SIP server X determines that the SIP server N is in the communication unavailable state based on the fact that the SIP server N returns no response, so that the SIP-call control unit 20 instructs the SIP-header control unit 30 to delete the information on the SIP server N from the transmission path set in the route header of the re-INVITE request. Accordingly, the destination of the re-INVITE request is changed to the SIP server A. The SIP-call control unit 20 transmits the re-INVITE request with the route header edited to the SIP server A via the SIP-communication control unit 10 (step S504).

With the same process procedure described at step S405 in connection with FIG. 6, the re-INVITE request transmitted from the SIP server X is transferred to the SIP server A based on the transmission path set in the route header and transferred from the SIP server A to the UAC (step S505).

In this manner, when the failure occurs in the SIP server N and the SIP server X does not detect the occurrence of the failure, the SIP-call control unit 20 in the SIP server X transmits the re-INVITE request to the SIP server N. If the response message to the re-INVITE request is not returned even after a predetermined time elapsed, the SIP server X determines that the SIP server N is in the communication unavailable state, so that the SIP server X skips the SIP server N to transmit the re-INVITE request to the SIP server A, which is the subsequent destination of the SIP server N. As a result, it is possible to continue the session communication between the UAC and the UAS.

As described above, the rerouting control unit 50 sends a query to the other-server-state managing unit 40 to determine the communication state between the SIP server to the destination SIP server designated as the destination of the request message. When it is determined that the communication state is in the abnormal state, the SIP-call control unit 20 sets a different SIP server other than the SIP server in the communication unavailable state as the destination of the SIP message based on the information on the relay order of the SIP servers included in the header information of the request message. Therefore, even after a failure occurs in the SIP server during the session communication, it is possible to transmit the SIP message to a last destination by skipping the failed SIP server. As a result, it is possible to continue the session communication between the UAC and the UAS.

Furthermore, the SIP-call control unit 20 transmits the SIP message to the destination SIP server, and determines the communication state between the SIP server and the destination SIP server based on the response message returned in response to the transmitted SIP message. Accordingly, it is possible to determine whether to skip the destination SIP server by determining the communication state by a detailed condition based on the communication state.

Moreover, the SIP-call control unit 20 determines the communication state based on the response code, which indicates the state of the SIP server and is included in the response message, so that, even when there is the SIP server of which service is temporarily unavailable due to a congestion or the like, it is possible to transmit the SIP message by skipping an unavailable SIP server. As a result, it is possible to continue the session communication between the UAC and the UAS.

Furthermore, when the response message is not returned in response to the transmitted SIP message, the SIP-call control unit 20 determines that the SIP server is in the communication unavailable state. Therefore, even when the SIP server is down due to the occurrence of the failure, it is possible to transmit the SIP message by skipping the down SIP server. As a result, it is possible to continue the session communication between the UAC and the UAS.

Moreover, when the rerouting control unit 50 determines that the communication state of the server and the destination SIP server is in the communication unavailable state, the SIP-call control unit 20 instructs the SIP-header control unit to delete the information on the destination SIP server set in the route header included in the SIP message to change the destination of the SIP message. Therefore, it is possible to transmit the SIP message by skipping the communication device in which the failure has occurred, without changing data structure of the header information specified by the SIP. As a result, it is possible to continue the session communication between the UAC and the UAS.

Although the re-INVITE request is described as the example, the present invention is not thus limited and can be applied to other request messages, such as the BYE request, to be transmitted after the session communication is started.

The SIP server including a function of a transmission-path setting device is described according to the above embodiment. Alternately, a transmission-path setting program including the same function can be obtained by realizing the configuration included in the SIP server by software. A computer terminal that executes the transmission-path setting program is described below.

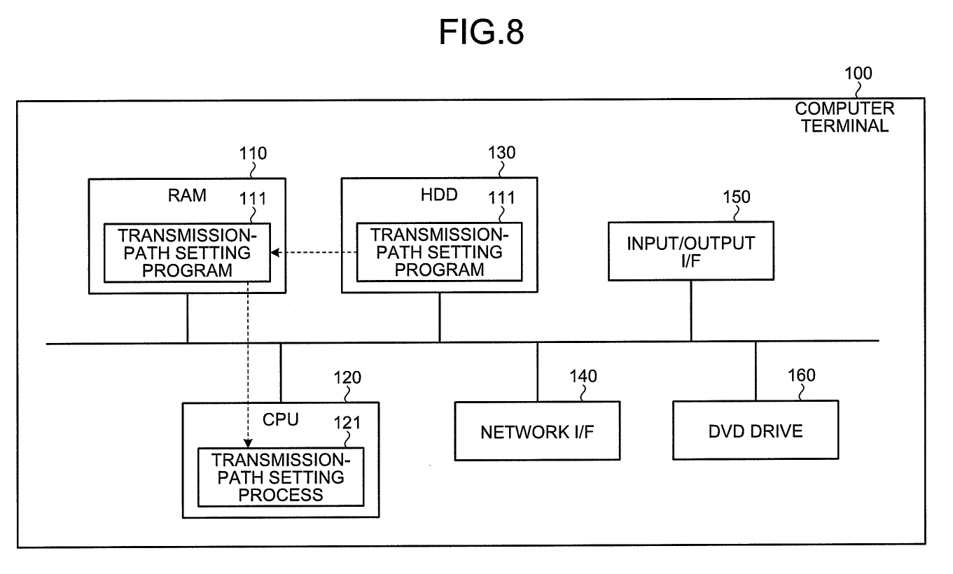

FIG. 8 is a functional block diagram of a computer terminal 100 that executes the transmission-path setting program. The computer terminal 100 includes a random access memory (RAM) 110, a central processing unit (CPU) 120, a hard disk drive (HDD) 130, a network interface (I/F) 140, an input/output I/F 150, and a digital versatile disk (DVD) drive 160.

The RAM 110 stores therein programs or an intermediate result of an execution of the program. The CPU 120 reads out and executes the program from the RAM 110.

The HDD 130 stores therein the programs or data. The network I/F is for connecting the computer terminal 100 to other computer terminal via the IP network.

The input/output I/F 150 is for connecting an input device, such as a mouse and a keyboard, and a display device to the computer terminal 100. The DVD drive 160 performs read/write of a DVD.

A transmission-path setting program 111 to be executed by the computer terminal 100 is stored in the DVD, so that the transmission-path setting program 111 is read out from the DVD by the DVD drive and installed in the computer terminal 100.

Alternately, the transmission-path setting program 111 is stored in a database of other computer system connected to the computer terminal 100 via the network I/F 140, so that the transmission-path setting program 111 is read out from the database and installed in the computer terminal 100.

The installed transmission-path setting program 111 is stored in the HDD 130, loaded on the RAM 110, and executed as a transmission-path setting process 121 by the CPU 120.

Although the network constituted of three SIP servers (the SIP servers A, N, and X) is described according to the embodiment, the present invention is not thus limited and a network can be constituted of three or less or more number of the SIP servers.

Furthermore, although the SIP server that constitutes the IP phone network is described above, the present invention can be applied to other general network using the SIP, such as a network that provides a service of a video conference or an instant message.

Of the various types of processing explained in the description of the embodiments, it is possible to manually perform a part or all of the processing that is explained to be performed automatically. Conversely, it is possible to automatically perform, using a publicly-known technique, a part or all of the processing that is explained to be performed manually.

In addition, the processing procedures, the controlling procedures, the specific names, and the information including various types of data and parameters that are presented in the text and the drawings can be modified in any form, except when it is noted otherwise.

The constituent elements of the apparatuses shown in the drawings are based on functional concepts. The constituent elements do not necessarily have to be physically arranged in the way shown in the drawings. In other words, the specific mode in which the constituent elements are distributed and integrated is not limited to the ones shown in the drawing.

A part or all of the apparatuses can be distributed or integrated, functionally or physically, in any arbitrary units according to various loads and use condition. A part or all of the processing functions offered by the constituent elements can be realized by a CPU and a program analyzed and executed by the CPU, or can be realized as hardware with wired logic.

According to an aspect of the present invention, even if a failure occurs in a communication device that relays a communication during the session communication, it is possible to transmit the SIP message by skipping a failed communication device. As a result, it is possible to continue a session communication between a source device and a destination device.

Furthermore, according to another aspect of the present invention, it is possible to determine whether to skip the communication device designated as the destination by determining the communication state with detailed condition based on the communication state.

Moreover, according to still another aspect of the present invention, even when there is the communication device of which service is temporarily unavailable due to a congestion or the like, it is possible to transmit the SIP message by skipping a failed communication device. As a result, it is possible to continue the session communication between the source device and the destination device.

Furthermore, according to still another aspect of the present invention, even when there is a communication device of which system is down due to the occurrence of the failure, it is possible to transmit the SIP message by skipping the down communication device. As a result, it is possible to continue the session communication between the source device and the destination device.

Moreover, according to still another aspect of the present invention, it is possible to transmit the SIP message by skipping the communication device in which the failure has occurred without changing data structure of the header information specified by the SIP. As a result, it is possible to continue the session communication between the source device and the destination device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus that sets a transmission path of a session initiation protocol message from a first communication device to a fourth communication device via a plurality of other communication devices that relay the session initiation protocol message based on information included in the session initiation protocol message, the communication devices being connected to each other via a network, the other communication devices including a second communication device that is downstream of the first communication device in the communication path, and a third communication device that is downstream of the second communication device in the communication path, the apparatus comprising:
a communication-state determining unit that determines a communication state between the first communication device and the second communication device; and
a transmission-path setting unit that changes the information included in the session initiation protocol message, when the communication-state determining unit determines that communication is unavailable between the first communication device and the second communication device, to change a destination of the session initiation protocol message from the second communication device to the third communication device.

2. The apparatus according to claim 1, wherein
the first communication device transmits the session initiation protocol message to the second communication device,
the second communication device returns a response message to the session initiation protocol message, and
the communication-state determining unit determines the communication state between the first communication device and the second communication device based on the response message.

3. The apparatus according to claim 2, wherein the communication-state determining unit determines the communication state between the first communication device and the second communication device based on the communication state included in the response message.

4. The apparatus according to claim 2, wherein the communication-state determining unit determines that the communication state is in the communication unavailable state when the response message is not received from the second communication device.

5. The apparatus according to claim 1, wherein
the session initiation protocol message includes a route header, and
the transmission-path setting unit deletes information about the second communication device from the route header when changing the destination of the session initiation protocol message from the second communication device to the third communication device.

6. A method of setting a transmission path of a session initiation protocol message from a first communication device to a fourth communication device via a plurality of other communication devices that relay the session initiation protocol message based on information included in the session initiation protocol message, the communication devices being connected to each other via a network, the other communication devices including a second communication device that is downstream of the first communication device in the communication path, and a third communication device that is downstream of the second communication device in the communication path, the method comprising:
determining a communication state between the first communication device and the second communication device; and
changing the information included in the session initiation protocol message, when it is determined at the determining that communication is unavailable between the first communication device and the second communication device, to change a destination of the session initiation protocol message from the second communication device to the third communication device.

7. The method according to claim 6, wherein the determining includes
transmitting the session initiation protocol message from the first communication device to the second communication device,
returning a response message to the session initiation protocol message from the second communication device to the first communication device, and
determining the communication state between the first communication device and the second communication device based on the response message at the first communication device.

8. The method according to claim 7, wherein the determining includes determining the communication state between the first communication device and the second communication device based on the communication state included in the response message.

9. The method according to claim 7, wherein the determining includes determining that the communication state is in the communication unavailable state when the response message is not received from the second communication device.

10. The method according to claim 6, wherein
the session initiation protocol message includes a route header, and
the changing includes deleting information about the second communication device from the route header when changing the destination of the session initiation protocol message from the second communication device to the third communication device.

11. A computer-readable recording medium that causes a computer to realize a method of setting a transmission path of a session initiation protocol message from a first communication device to a fourth communication device via a plurality of other communication devices that relay the session initiation protocol message based on information included in the session initiation protocol message, the communication devices being connected to each other via a network, the other communication devices including a second communication device that is downstream of the first communication device in the communication path, and a third communication device that is downstream of the second communication device in the communication path, the computer program causing the computer to execute:
determining a communication state between the first communication device and the second communication device; and
changing the information included in the session initiation protocol message, when it is determined at the determining that communication is unavailable between the first communication device and the second communication device, to change a destination of the session initiation protocol message from the second communication device to the third communication device.
